(19) United States
(12) Patent Application Publication
(10) Pub. No.: US 2017/0155702 A1
(43) Pub. Date: Jun. 1, 2017

(54) CLIENT AND METHOD FOR RECOMMENDING FILE OPENING TOOL

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Lei QIAO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,374

(22) Filed: Aug. 22, 2016

Related U.S. Application Data
(63) Continuation of application No. PCT/CN2016/089512, filed on Jul. 10, 2016.

(30) Foreign Application Priority Data
Dec. 1, 2015 (CN) 2015108610537

(51) Int. Cl. H04L 29/08; H04L 29/06; G06F 17/30

(52) U.S. Cl. CPC H04L 67/06; G06F 17/30115; H04L 67/10; H04L 67/42

(57) ABSTRACT

An embodiment of the present disclosure discloses a user device, server, system, and method for recommending a file opening tool. The user device includes: a receiver configured to receive an instruction for opening a file; a display; and a processor coupled with the receiver and the display, configured to: use an application (APP) corresponded with the file to open the file according to the instruction received by the receiver; extract an information about a MIME type or suffix of the file when the APP is not found in the client; determine one or more APPs that support the MIME type or suffix of the file; and prompt, on the display, the one or more APPs that support the MIME type or suffix of the file. By means of the foregoing technical solution, when a user cannot open a file on a client due to lack of a corresponding APP, the user may obtain recommended APPs on a display of the client, select an APP from the recommended APPs to download, and use the downloaded APP to open the file to be opened, so as to provide convenience for the user.

### CROSS-REFERENCE TO RELATED APPLICATIONS

This application is a continuation of International Application No. PCT/CN2016/089512, with an international filing date of Jul. 10, 2016, which is based upon and claims priority to Chinese Patent Application No. 201510861053.7, filed on Dec. 1, 2015, the entire contents of both of which are incorporated herein by reference.

### TECHNICAL FIELD

The present disclosure relates to the field of information technologies, and in particular, to a client and method for recommending a file opening tool.

### BACKGROUND

As development of computer technologies, a wide variety of programs generate various types of files. When a user intends to open a file of a certain type on a mobile phone thereof (for example, a file downloaded to the mobile phone (the mobile phone is also called as a client during this application) from the Internet or a file transferred from a computer to the mobile phone) while the mobile phone lacks an application program for opening this type of file, then the mobile phone displays a prompt that the file cannot be opened. In this case, the user needs to search for an application (APP as its abbreviation) suitable for this type of file on the Internet and download the APP, and then use the APP to open the type of file. This process is relatively complex, causing a lot of inconvenience for the user.

### SUMMARY

An objective of some embodiments of the present disclosure is to provide a client and method for recommending a file opening tool, which can recommend a suitable APP for a user to open a file that the user intends to open.

To achieve the foregoing objective, an embodiment of the present disclosure provides a client for recommending a file opening tool, where the client includes: a receiver configured to receive an instruction for opening a file; a display; and a processor coupled with the receiver and the display, configured to: use an application (APP) corresponded with the file to open the file according to the instruction received by the receiver; extract a Multipurpose Internet Mail Extensions (MIME) type or suffix of the file when the APP is not found in the client; determine one or more APPs that support the MIME type or suffix of the file; and prompt, on the display, the one or more APPs that support the MIME type or suffix of the file.

The processor searches for the APP that supports the MIME type or suffix in a pre-stored corresponding table, wherein the corresponding table indicates corresponding relationships between MIME types or suffixes and APPs.

The client further includes: a transmitter, configured to send the extracted information about MIME type or suffix of the file to a server; and the receiver further configured to receive, from the server, the information about the one or more APPs that support the MIME type or suffix.

When one MIME type or suffix corresponds to multiple APPs, one or more APPs with a tag type of document or tool is pushed preferentially.

Correspondingly, another embodiment of the present disclosure provides a method for recommending a file opening tool at a user device, where the method includes: receiving an instruction for opening a file; using an application (APP) corresponded with the file to open the file according to the instruction received by the receiver; extracting an information about MIME (Multipurpose Internet Mail Extensions) type or suffix of the file when the APP is not found in the client; determining one or more APPs that support the MIME type or suffix of the file; and prompting, on a display, the one or more APPs that support the MIME type or suffix of the file.

The determining an APP that supports the MIME type or suffix includes searching for the APP that supports the MIME type or suffix in a pre-stored corresponding table, wherein the corresponding table indicates corresponding relationships between MIME types or suffixes and APPs.

The determining an APP that supports the MIME type or suffix includes: sending the extracted information about MIME type or suffix of the file to a server; and receiving, from the server, the information about the one or more APPs that support the MIME type or suffix.

When one MIME type or suffix corresponds to multiple APPs, one or more APPs with a tag type of document or tool is pushed preferentially.

According to an embodiment of the present disclosure, there is provided with a non-transitory computer-readable storage medium storing executable instructions that, when executed by an electronic apparatus, cause the electronic apparatus to perform an above disclosed method.

According to an embodiment of the present disclosure, there is provided with an electronic apparatus. The electronic apparatus includes: at least one processor; and a memory communicably connected with the at least one processor for storing instructions executable by the at least one processor, wherein execution of the instructions by the at least one processor causes the at least one processor to perform an above disclosed method.

By means of the foregoing technical solutions, when a user cannot open a file on a user device due to lack of a corresponding APP, the user may obtain recommended APPs on a display of the user device, select an APP from the recommended APPs to download, and use the downloaded APP to open the file to be opened, so as to provide convenience for the user.

Other features and advantages of the present disclosure will be described in detail in the following specific implementation manners.

### BRIEF DESCRIPTION OF THE DRAWINGS

The accompanying drawings, which constitute a part of the specification, are used to provide further understanding of some embodiments of the present disclosure, and are used for comprehension of the present disclosure together with the specific implementation manners below, but do not constitute any limitation on the present disclosure. In the accompanying drawings:

FIG. 1 is a structural diagram of a system for recommending a file opening tool according to an embodiment of the present disclosure;

FIG. 2 is a flowchart of information processing by a client according to an embodiment of the present disclosure; and

FIG. 3 is a flowchart of interaction between a user device and a server according to an embodiment of the present disclosure.

FIG. 4 is a schematic hardware diagram of an electronic apparatus for performing a method according to an embodiment of the present disclosure.

List of reference numerals:

| | | | |
|---|---|---|---|
| 100 | User device | 110 | Receiver |
| 120 | Processor | 130 | Display |
| 140 | Transmitter | 200 | Server |
| 210 | Receiving apparatus | 220 | Processing apparatus |
| 230 | Sending apparatus | | |

### DETAILED DESCRIPTION

Specific implementation manners of some embodiments of the present disclosure are described in detail below with reference to the accompanying drawings. It should be understood that the specific implementation manners described herein are merely used for illustration and comprehension of the present disclosure, but are not intended to limit the present disclosure.

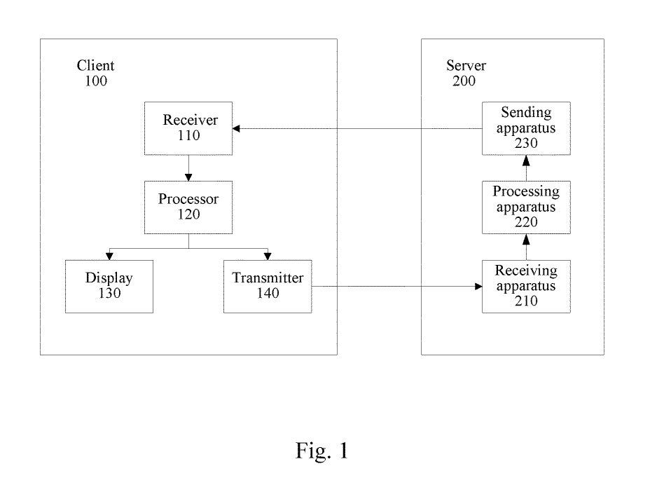

FIG. 1 is a structural diagram of a system for recommending a file opening tool according to an embodiment of the present disclosure. As shown in FIG. 1, an embodiment of the present disclosure provides a system for recommending a file opening tool, where the system includes: a client 100; and a server 200.

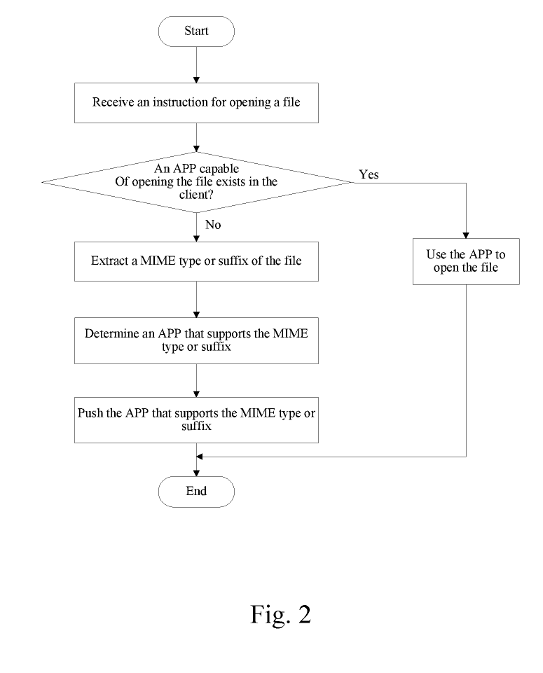

The client 100 includes: a receiver 110 configured to receive an instruction for opening a file entered by a user; a display 130; and a processor 120 coupled with the receiver 110 and the display 130, the processor 120 is configured to execute the following operations: using a corresponding application (abbreviated as APP) to open the file according to the instruction for opening the file; when an APP for opening the file exists in the client 100, using the APP to open the file; or extracting a MIME (Multipurpose Internet Mail Extensions) type or suffix of the file when the APP does not exist in the client 100; determining an APP that supports the MIME type or suffix of the file; and prompting, on the display 130, the one or more APPs that support the MIME type or suffix. One or more APPs that support the MIME type or suffix may be pushed, and in a case of multiple APPs, the user may select from the multiple APPs to download. An information processing process of the client 100 is shown in FIG. 2. In this way, the user may select a suitable APP according to the pushed information to download, and then use the downloaded APP to open the file.

As for how the client 100 determines an APP that supports the MIME type or suffix, the following two approaches may be considered.

1) The processor 120 searches for the APP that supports the MIME type or suffix in a pre-stored correspondence table that includes corresponding relationships between MIME types or suffixes and APPs. In this approach, the client 100 stores the correspondence table, where the correspondence table may be from the server, and is updated by the server periodically.

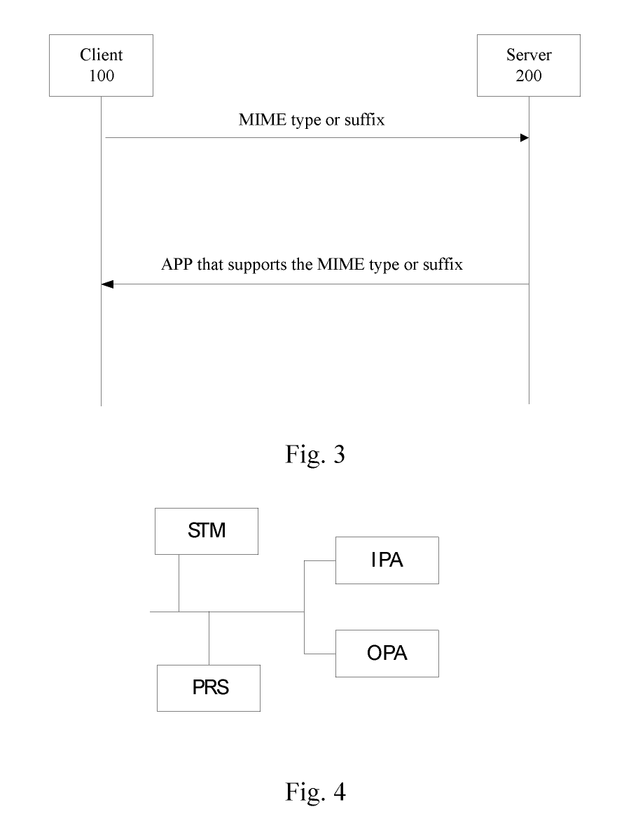

2) The processor 12 controls a transmitter 140 of the client 100 to send the extracted MIME type or suffix of the file to the server 200. A receiving apparatus 210 of the server 200 receives the MIME type or suffix from the user device, and a processing apparatus 220 searches, according to the MIME type or suffix, for the APP that supports the MIME type or suffix in a pre-stored correspondence table that includes corresponding relationships between MIME types or suffixes and APPs, and a sending apparatus 230 of the server sends the APP that supports the MIME type or suffix to the user device. Thereafter, the client 100 determines the APP that supports the MIME type or suffix, according to the received APP that supports the MIME type or suffix. An interaction process of this approach is shown in FIG. 3. In this approach, the server 200 stores the correspondence table, and may update the correspondence table periodically.

The server 200 may parse all APPs stored in the server 200, to obtain a configuration file, i.e., a manifest file, of each APP, where the file includes a MIME type or suffix (for example, .pdf, .doc, and .txt, etc.) supported by the APP. Thereafter, the server may determine the MIME type or suffix supported by each APP according to the configuration file of each APP, and generates the correspondence table that includes the corresponding relationships between the MIME types or suffixes and the APPs.

In the correspondence table, it is very likely that a certain MIME type or suffix corresponds to multiple APPs, that is, all these multiple APPs can open the file that has the MIME type or suffix. In this case, the server may acquire installation quantities of the multiple APPs, select several top ranking APPs in terms of installation quantity (for example, APPs having TOP3 installation quantities), and store these APPs into the correspondence table. A greater installation quantity of an APP generally can reflect popularity and function reliability of the APP, and providing the APP for the user can meet a requirement for opening the file. Optionally, the server may further acquire tag types of the multiple APPs, select APPs with tag types of document or tool, and store these APPs into the correspondence table. Because such document or tool type of APPs generally have relatively simple functions and are tools that are specifically made for opening the file, they are of relatively smaller file sizes, easier to download, and more suitable for a user. Optionally, an operator may further perform manual testing or other manual intervention on the APPs stored in the correspondence table, to eliminate APPs which the operator considers unsatisfying for the requirement of a user. Certainly, for APPs corresponding to each MIME type or suffix stored in the correspondence table, a rule for determining which APP to be pushed to a user preferentially is not limited to the foregoing rules based on installation quantity, tag type, and manual testing. Any of these rules, other predictable rules for persons skilled in the art and any combination of such rules are also possible, and the present disclosure is not limited thereto.

The manner in which the server maintains the correspondence table is described above. Optionally, the foregoing maintenance may not be performed on the correspondence table; instead, the server finds, in the correspondence table, multiple APPs that support the MIME type or suffix, selects some APPs from the multiple APPs according to the foregoing rules, and sends the selected APPs to the user device. Furthermore, the user device may according to the foregoing rules select some APPs from the multiple APPs, which are found in the correspondence table received from the server or stored in the user device, to push to the display.

By means of the foregoing technical solutions, when a user cannot open a file on a user device due to lack of a corresponding APP, the user may obtain recommended APPs on a display of the client, select an APP from the recommended APPs to download, and use the downloaded APP to open the file to be opened, so as to provide convenience for the user.

According to an embodiment of the present disclosure, there is provided with a non-transitory computer-readable storage medium storing executable instructions that, when executed by an electronic apparatus, cause the electronic apparatus to perform any one of above disclosed methods.

FIG. 6 illustrates a schematic hardware diagram of an electronic apparatus for performing any one of above disclosed methods. According to FIG. 6, the electronic apparatus includes one or more processors PRS and a storage medium STM. FIG. 6 shows one processor PRS as an example.

The electronic apparatus can further include an input apparatus IPA and an output apparatus OPA.

The one or more processors PRS, storage medium STM and output apparatus OPA may be connected by a bus or other means. FIG. 6 shows a bus as an example for connection.

Storage medium STM is a non-transitory computer-readable medium for storing a non-transitory software program, a non-transitory computer-readable program and module, for example the program instructions/module for performing an above described method (e.g. processor 120 and processing apparatus 220 shown in FIG. 1). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player(e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Preferred implementation manners of some embodiments of the present disclosure are described in detail above with reference to the accompanying drawings. However, the present disclosure is not limited to specific details in the foregoing implementation manners. Multiple simple variations may be made to the technical solutions of the present disclosure within the technical concept scope of the present disclosure, and all such simple variations belong to the protection scope of the present disclosure.

It should be additionally noted that, the various specific technical features described in the foregoing specific implementation manners may be combined in any proper manner as long as it does not cause a conflict. To avoid unnecessary repetition, various possible combination manners are not additionally described in the present disclosure.

In addition, any combination of various different implementation manners of the present disclosure may also be possible and shall also be considered as the disclosure of the present disclosure as long as it does not depart from the spirit of the present disclosure.

What is claimed is:

1. A client for recommending a file opening tool, comprising:
a receiver configured to receive an instruction for opening a file;
a display; and
a processor coupled with the receiver and the display, configured to:
use an application (APP) corresponded with the file to open the file according to the instruction received by the receiver;
extract an information about Multipurpose Internet Mail Extensions (MIME) type or suffix of the file when the APP is not found in the client;
determine one or more APPs that support the MIME type or suffix of the file; and
prompt, on the display, the one or more APPs that support the MIME type or suffix of the file.

2. The client according to claim 1, wherein the processor further configured to: search for the APP that supports the MIME type or suffix in a pre-stored corresponding table, wherein the corresponding table indicates corresponding relationships between MIME types or suffixes and APPs.

3. The client according to claim 1, wherein the user device further comprises:
a transmitter, configured to send the extracted information about MIME type or suffix of the file to a server; and
the receiver further configured to receive, from the server, the information about the one or more APPs that support the MIME type or suffix.

4. The client according to claim 1, wherein when one MIME type or suffix corresponds to multiple APPs, one or more APPs with a tag type of document or tool is pushed preferentially.

5. A method performed by a client for recommending a file opening tool, comprising:
receiving an instruction for opening a file;
using an application (APP) corresponded with the file to open the file according to the instruction received by the receiver;
extracting an information about Multipurpose Internet Mail Extensions (MIME) type or suffix of the file when the APP is not found in the client;
determining one or more APPs that support the MIME type or suffix of the file; and
prompting, on a display, the one or more APPs that support the MIME type or suffix of the file.

6. The method according to claim 5, wherein the determining an APP that supports the MIME type or suffix comprises:
searching for the APP that supports the MIME type or suffix in a pre-stored corresponding table,wherein the corresponding table indicates corresponding relationships between MIME types or suffixes and APPs.

7. The method according to claim 5, wherein the determining an APP that supports the MIME type or suffix comprises:
sending the extracted information about MIME type or suffix of the file to a server; and
receiving, from the server, the information about the one or more APPs that support the MIME type or suffix.

8. The method according to claim 5, wherein when one MIME type or suffix corresponds to multiple APPs, one or more APPs with a tag type of document or tool is pushed preferentially.

9. A non-transitory computer-readable storage medium storing executable instructions that, when executed by an electronic apparatus, cause the electronic apparatus to:
after the electronic apparatus receives an instruction for opening the file, use anapplication (APP) corresponded with the file to open the file according to the instruction received by the receiver;
extract an information about Multipurpose Internet Mail Extensions (MIME) type or suffix of the file when the APP is not found in the user device;
determine one or more APPs that support the MIME type or suffix of the file; and
prompt, on a display, the one or more APPs that support the MIME type or suffix of the file.

10. The storage medium according to claim 9, wherein the storage medium comprises instructions to search for the APP that supports the MIME type or suffix in a pre-stored corresponding table, wherein the corresponding table indicates corresponding relationships between MIME types or suffixes and APPs.

11. The storage medium according to claim 9, wherein when one MIME type or suffix corresponds to multiple APPs, one or more APPs with a tag type of document or tool is pushed preferentially.
